(19) United States
(12) Patent Application Publication
(10) Pub. No.: US 2026/0142721 A1
(43) Pub. Date: May 21, 2026

(54) METHOD FOR IMPLEMENTING RATE-ADAPTIVE MULTI-INPUT SINGLE-OUTPUT VISIBLE LIGHT COMMUNICATION SYSTEM

(71) Applicant: CHONGQING UNIVERSITY, Chongqing (CN)

(72) Inventors: Jia YE, Chongqing (CN); Tiantian CHU, Chongqing (CN); Chen CHEN, Chongqing (CN)

(73) Assignee: CHONGQING UNIVERSITY, Chongqing (CN)

(21) Appl. No.: 19/230,955

(22) Filed: Jun. 6, 2025

(30) Foreign Application Priority Data
Nov. 21, 2024 (CN) 202411672772.X

(51) Int. Cl. H04B 10/116; H04B 10/516

(52) U.S. Cl. CPC H04B 10/116; H04B 10/516

(57) ABSTRACT

Disclosed is a method for implementing a rate-adaptive multi-input single-output visible light communication system, where the visible light communication system includes transmit ends and a receiver end. Binary transmission data streams corresponding to the transmit ends are respectively modulated onto a constellation diagram, and all transmit constellations are loaded onto a signal generator after subjected to digital signal processing, the signal generator outputs analog signals, which are respectively amplified by electrical amplifiers, and then coupled to direct current by biasers, and the light sources corresponding to the transmit ends convert the electric signals obtained by coupling into optical signals. The probabilistic shaping is performed on all the transmit constellations respectively so as to enable same to conform to Maxwell-Boltzmann distribution of a QAM constellation; and geometric shaping is performed on all the transmit constellations at the same time to make a transmit signal power of each transmit end equal.

### CROSS-REFERENCE TO RELATED APPLICATION

The present disclosure claims priority to patent application no. 202411672772.X, entitled “Method for Implementing Rate-Adaptive Multi-Input Single-Output Visible Light Communication System,” and filed to the China National Intellectual Property Administration on Nov. 21, 2024.

### TECHNICAL FIELD

The present disclosure relates to visible light communication, and in particular to a method for implementing a rate-adaptive multi-input single-output visible light communication system, which belongs to the technical field of wireless optical communications.

### BACKGROUND

With the surge of emerging services and the expansion of hyperscale connectivity, the rapidly growing demand for mobile network data traffic has created a sharp contradiction with the increasingly scarce availability of Radio Frequency (RF) spectrum. Visible Light Communication (VLC) offers many advantages such as abundant and unregulated spectrum resources, no electromagnetic interference, high efficiency and energy-saving, and is regarded as a key enabling technology for 6G mobile networks.

In Point-to-Multipoint (PtMP) networks, VLC systems can serve multiple mobile or fixed user terminals while providing the same bandwidth and lighting resources. A PtMP VLC system using a single modulation format suffers from low bandwidth utilization efficiency. Switching modulation formats according to a user's Signal-to-Noise Ratio (SNR) budget can only partially address this issue, as there still exists a significant SNR gap between adjacent Regular Quadrature Amplitude Modulation (R-QAM) formats. A Probabilistic Shaping (PS) rate-adaptive Single-Input Single-Output (SISO) VLC system can flexibly provide data rates close to channel capacity for different users. Increasing the transmitted optical power is an effective way to improve SNR and then enhance the achievable data rate for users. However, the transmitted optical power in VLC systems is limited by the nonlinear effects of Light-Emitting Diodes (LEDs). As a result, the system design with a single transmitter constrains the overall achievable data rate for all users.

The nonlinear constraints of LEDs can be mitigated by increasing the number of parallel transmitters. Multi-Input Single-Output (MISO) VLC systems in multipoint to multipoint networks can serve not only multiple user terminals, but also can achieve considerable space diversity gain. However, the optical front-end of VLC systems employs Intensity Modulation/Direct Detection (IM/DD) technology, which causes MISO VLC channels to always be highly correlated. The minimal difference in channel gains results in a rank-deficient channel matrix, making the MISO demultiplexing methods used in RF communication systems unsuitable for direct application in VLC systems.

Superposition Coded Modulation (SCM) is robust to highly correlated MISO VLC channels. The Power Ratio (PR) between transmit signals determines the Minimum Euclidean Distance (MED) of the superimposed constellation at the receiver end, making it a critical factor affecting the performance of SCM VLC systems. A PR of 1 is optimal, and deviation from 1 can cause high-power signals to more easily fall into the non-linear region of LEDs and lead to power contention at the Photodetector (PD). Geometric Shaping (GS) can make the optimal PR of the SCM scheme equal to 1, but a universal GS method has not yet been proposed. Moreover, if the transmit signals are non-equivalent, the optimal PR varies with changes in the Probabilistic Shaping Factor (PSF).

Therefore, there is an urgent need to propose a method for implementing a rate-adaptive MISO VLC system to address the above issues and improve the utilization efficiency of bandwidth and space resources.

### SUMMARY

The present disclosure proposes a method for implementing a rate-adaptive multi-input single-output visible light communication system.

The technical solution of the present disclosure is implemented as follows:
a method for implementing a rate-adaptive multi-input single-output visible light communication system, where the visible light communication system includes transmit ends and a receiver end, and there are a plurality of transmit ends and one receiver end, thereby forming the multi-input single-output visible light communication system; each transmit end corresponds to one light source; binary transmission data streams corresponding one-to-one to the plurality of transmit ends are respectively modulated onto a constellation diagram so as to increase spectrum efficiency and then obtain transmit constellations, all the transmit constellations are loaded onto a signal generator after subjected to digital signal processing, the signal generator outputs a plurality of analog signals corresponding to a number of the transmit constellations, and the plurality of analog signals are respectively amplified by electrical amplifiers, and then coupled to direct current by biasers, the light sources corresponding to the plurality of transmit ends convert a plurality of electric signals obtained by means of coupling into optical signals, and the receiver end is used for receiving the optical signals;
probabilistic shaping is performed respectively on all the transmit constellations so as to enable same to conform to Maxwell-Boltzmann distribution of a QAM constellation; and geometric shaping is performed on all the transmit constellations at the same time to make a transmit signal power of each transmit end equal.

Further, during probabilistic shaping, a Constant Composition Distribution Matching is used to perform probabilistic shaping on the transmit constellations, and in a case that there are two transmit ends, a probability distribution of QAM signals of which a modulation order is M is:

$${P}_{{X}_{i}} ( x ) = \frac{{e}^{- v \vert x {\vert}^{2}}}{{\sum }_{{x}^{′} ∈ {X}_{i}} {e}^{- v \vert {x}^{′} {\vert}^{2}}} , i = 1 , 2$$

where Xᵢ represents a complex coordinate set of an ith lower order M-QAM constellation of the transmit ends, and X={x₀, x₁, . . . , x_{M-1}}; x and x′ represent constellation symbols; v is a probabilistic shaping factor for controlling the Source Entropy (SE), a value of which is between 0 and 1; and there is a one-to-one mapping relationship between the SE and the probabilistic shaping factor v.

Still further, the SE is determined according to the following steps,
1) a lookup table indicating a relationship of at least one normalized generalized mutual information, at least one signal-to-noise ratio and the at least one SE is established;
2) a threshold of the normalized generalized mutual information is determined as a value of normalized generalized mutual information for lookup; and
3) the signal-to-noise ratio is obtained by estimation, and based on the lookup table of step 1), a maximum SE of each scheme which can satisfy the threshold of the normalized generalized mutual information is determined.

Further, during geometric shaping, an optimal geometric shaping factor is solved in advance, and then geometric shaping is performed on the transmit constellations based on the obtained optimal geometric shaping factor, where the optimal geometric shaping factor is defined as a geometric shaping factor when each transmit signal power ratio is equal to 1 and superposed constellations of the receiver end are evenly distributed.

Still further, the optimal geometric shaping factor is determined according to the following steps,
a) geometric shaping factors are added to an in-phase component and a quadrature component of two transmit signals, respectively;
b) an optimal power ratio of the two transmit signals is preset to be 1, and a symbol set of the superimposed constellations of the receiver end is obtained;
c) the elements of the symbol set are formed into an arithmetic progression with a tolerance of the minimum Euclidean distance; and
d) an equation set with regard to the geometric shaping factor is established based on the arithmetic progression in step c), and the geometric shaping factor obtained by solving the equation set is the optimal geometric shaping factor.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a GS SCM scheme of the present disclosure, where (a) MISO-GS(4,4); (b) MISO-GS(8,8); and (c) MISO-GS(16,16);

FIG. 2 is a schematic diagram of probability distribution of a hybrid GPS SCM scheme of the present disclosure, where (a) MISO-GS(4,4), H=3.9 bit/symbol; (b) MISO-GS(8,8), H=5.9 bit/symbol; and (c) MISO-GS(16,16), H=7.9 bit/symbol;

FIG. 3 is a schematic diagram of an NGMI lookup table of a hybrid GPS SCM scheme of the present disclosure, where (a) MISO-GS(4,4); (b) MISO-GS(8,8); and (c) MISO-GS(16,16);

FIG. 4 is a system block diagram and an experimental device diagram of an SCM-based hybrid GPS rate-adaptive MISO VLC system according to the present disclosure;

FIG. 5 is a schematic diagram of features of a VLC experimental system of the present disclosure, where (a) frequency response; (b) amplitude-amplitude response in a linear region; and (c) amplitude-amplitude response in a nonlinear region;

FIG. 6 is a comparison diagram of NGMI performances under different scenarios according to the present disclosure, where (a) NGMI performances of MISO-GS(16,16) and MISO-R(16,16) schemes at different Vppₜₒₜₐₗ; (b) NGMI performances of MISO-GPS(16,16) and MISO-PS(16,16) schemes at different Vpp₁; and (c) constellation of marker points;

FIG. 7 is a schematic diagram of performances of MISO-GS(16,16) and SISO-R(256) schemes at different Vppₜₒₜₐₗ according to the present disclosure, where (a) NDR and NGMI; and (b) AIR and GMI;

FIG. 8 is a schematic diagram of performances of MISO-GPS(16,16) and SISO-PS(256) schemes at different Vppₜₒₜₐₗ according to the present disclosure, where (a) NDR and NGMI; and (b) AIR and GMI;

FIG. 9 is a comparison diagram of the NDP and NGMI performances of various rate-adaptive VLC systems at different Vppₜₒₜₐₗ according to the present disclosure; and

FIG. 10 is a comparison diagram of the NDR performances of various rate-adaptive VLC systems at different distances according to the present disclosure.

### DETAILED DESCRIPTION OF THE EMBODIMENTS

To address the problem of low bandwidth and spatial resource utilization efficiency in single-input single-output visible light communication systems with existing modulation formats, the object of the present disclosure is to propose a method for implementing a rate-adaptive multi-input single-output visible light communication system. The present disclosure utilizes a SCM-based hybrid Geometric-Probabilistic Shaping (GPS) rate-adaptive Multiple-Input Single-Output Visible Light Communication (MISO VLC) system to fully utilize the bandwidth and space resources, and provide flexible high data rates close to channel capacity for each user.

The present disclosure provides a method for implementing a rate-adaptive multi-input single-output visible light communication system. The visible light communication system includes transmit ends and a receiver end, where there are a plurality of transmit ends, each transmit end corresponds to one light source, and there is one receiver end, thereby forming the multi-input single-output visible light communication system. Binary transmission data streams corresponding to the plurality of transmit ends on a one-to-one basis are respectively modulated onto a constellation diagram so as to increase spectrum efficiency and then obtain transmit constellations, and all the transmit constellations are loaded onto a signal generator after subjected to digital signal processing, the signal generator outputs a corresponding number of analog signals, which are respectively amplified by electrical amplifiers, and then coupled to direct current via biasers, the light sources corresponding to the plurality of transmit ends convert a plurality of electric signals obtained by means of coupling into optical signals, and the receiver end is used for receiving the optical signals.

The present disclosure distributes the total power across a plurality of LEDs, reducing the risk of nonlinear distortion in LEDs under the same total power budget, increasing the system's maximum transmit power tolerance, and thereby improving the received signal-to-noise ratio.

In the present disclosure, the probabilistic shaping is performed on all the transmit constellations respectively so as to enable same to conform to Maxwell-Boltzmann distribution of a QAM constellation; and the geometric shaping is performed on all the transmit constellations at the same time to make the transmit signal power of each transmit end equal. By means of the geometric-probabilistic hybrid shaping policy, the present disclosure enhances the robustness the system to non-ideal factors such as non-linear distortion, high channel correlation, power contend, and dynamic change of power ratio.

The proposed SCM-based hybrid GPS rate-adaptive multiple-input single-output visible light communication (MISO VLC) system in the present disclosure can provide a flexible and fine-grained net data rate (NDR) for each user while improving the overall NDR performance for all users.

In order to better understand the implementation principle and solution of the present disclosure, the specific embodiments of the present disclosure will be described in detail below with reference to the accompanying drawings.

In order to clearly illustrate the technical solution and the gist of the present disclosure, a naming rule is first established: A-B(M₁,M₂). “A” denotes MISO or SISO, and represents the type of VLC system. “B” denotes GPS, GS, PS, or R, R means no shaping, and represents the type of constellation. “M₁” and “M₂” denote modulation orders of two transmit signals. When “A” is SISO, “M₂” is omitted. For example, MISO-GPS(16,16) represents an MISO VLC system in which two transmit signals are both GPS-16QAM, and SISO-PS(256) represents an SISO VLC system in which the transmit signal is PS-16QAM.

### Regarding Geometric Shaping

This geometric shaping criterion ensures that the optimal power ratio of the hybrid GPS SCM scheme is 1, reducing the risks of nonlinear distortion in LEDs and power contention between photodetectors.

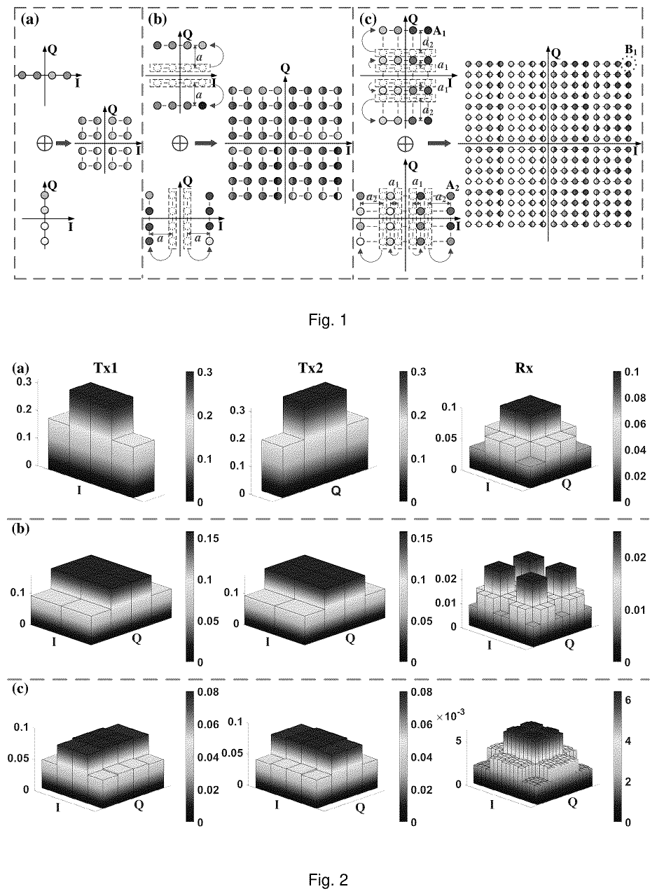

The GS SCM scheme is as shown in FIG. 1. A circle with a dashed grey line represents an initial position of each constellation point, and a circle with a solid color line represents the position of the constellation point after geometric shaping. The color composition of the superposed constellation points details the superposition mechanism of each scheme. The two transmit signals of the MISO-GS(4,4) scheme are 4QAM signals in an in-phase (I) component and a quadrature (Q) component, respectively. The transmit signals of the MISO-GS(8,8) and MISO-GS(16,16) schemes are two GS-8QAM signals and two GS-16QAM signals, respectively. The optimal power ratio of all the GS SCM schemes is 1. The two transmit signals of each GS SCM scheme have the same amplitude and different phases. Due to the IM/DD, the VLC system transmits amplitude information via light intensity, the two transmit signals may be considered equivalent.

Before power normalization, the Minimum Euclidean Distance (MED) of the transmit signals is equal to 2. Therefore, the two transmit signals without geometric shaping are represented as:

$$\{ \begin{matrix}{I}_{{x}_{1}} ∈ \{ 0 , \pm 1 , \pm 3 , … , \pm ( {N}_{1} - 1 ) \} \\ {Q}_{{x}_{1}} ∈ \{ 0 , \pm 1 , \pm 3 , … , \pm ( {N}_{2} - 1 ) \} \\ {I}_{{x}_{2}} ∈ \{ 0 , \pm 1 , \pm 3 , … , \pm ( {N}_{3} - 1 ) \} \\ {Q}_{{x}_{2}} ∈ \{ 0 , \pm 1 , \pm 3 , … , \pm ( {N}_{4} - 1 ) \}\end{matrix} \qquad ( 1 )$$

where N₁, N₂, N₃, and N₄ are all positive even numbers.

The superimposed constellation may be regarded as a linear superposition of two transmit constellations on the I and Q components, which are represented as:

$$\{ \begin{matrix}{I}_{y} ∈ \{ {p}_{1} \cdot {I}_{{x}_{1}} + {p}_{2} \cdot {I}_{{x}_{2}} \} \\ {Q}_{y} ∈ \{ {p}_{1} \cdot {Q}_{{x}_{1}} + {p}_{2} \cdot {Q}_{{x}_{2}} \}\end{matrix} \qquad ( 2 )$$

where p₁ and p₂ respectively represent power coefficients of the two transmit signals.

Without loss of generality, the MISO-GS(16,16) scheme is taken as an example to describe the method for solving the optimal geometric shaping factor. The values of N₁, N₂, N₃, and N₄ are all 4. Therefore, formula (1) is rewritten as:

$${I}_{{x}_{1}}^{′} , {Q}_{{x}_{1}}^{′} , {I}_{{x}_{2}}^{′} , {Q}_{{x}_{2}}^{′} ∈ \{ \pm 1 , \pm 3 \} \qquad ( 3 )$$

Given the target power ratio is 1, and both p₁ and p₂ are set to 1. Formula (2) is rewritten as:

$${I}_{y}^{′} , {Q}_{y}^{′} ∈ \{ 0 , \pm 2 , \pm 4 , \pm 6 \} \qquad ( 4 )$$

According to formula (4), both the I and Q components of the superimposed constellation are only 7 levels. The performance of SCM MISO VLC system may deteriorate significantly due to severe overlap of superimposed constellation points.

The SCM scheme is optimized by geometric shaping. The optimal geometric shaping factor is defined as a geometric shaping factor when the power ratio is equal to 1 and the superimposed constellations of the receiver end are evenly distributed. As shown in section (c) of FIG. 1, two geometric shaping factors a₁ and a₂ are introduced into the Q and I components of the two transmit signals respectively, where a₂≥a₁≥0. The signal levels of the two GS-16QAM constellations are represented as:

$$\{ \begin{matrix}{I}_{{x}_{1}}^{″} ∈ \{ \pm 1 , \pm 3 \} \\ {Q}_{{x}_{1}}^{″} ∈ \{ \pm ( 1 + {a}_{1} ) , \pm ( 3 + {a}_{2} ) \} \\ {I}_{{x}_{2}}^{″} ∈ \{ \pm ( 1 + {a}_{1} ) , \pm ( 3 + {a}_{2} ) \} \\ {Q}_{{x}_{2}}^{″} ∈ \{ \pm 1 , \pm 3 \}\end{matrix} \qquad ( 5 )$$

p₁ and p₂ both are set to be equal to 1, i.e. the power ratio is 1, and an optimal geometric shaping factor is solved. In this case, the signal level of the superposed constellation is expressed as:

$${I}_{y}^{″} , {Q}_{y}^{″} ∈ \{ \pm ( - 2 + {a}_{1} ) , \pm {a}_{1} , \pm ( 2 + {a}_{1} ) , \pm ( 4 + {a}_{1} ) , \pm {a}_{2} , \pm ( 2 + {a}_{2} ) , \pm ( 4 + {a}_{2} ) , \pm ( 6 + {a}_{2} ) \} \qquad ( 6 )$$

Before power normalization, the MED of the superimposed constellation is equal to 2. The signal level should be an arithmetic progression with a tolerance of 2. Thus, the following equation set is established:

$$\{ \begin{matrix}( - 4 - {a}_{1} ) - ( - {a}_{2} ) = 2 \\ ( - 2 + {a}_{1} ) - ( 2 - {a}_{1} ) = 2 \\ {a}_{2} - ( 4 + {a}_{1} ) = 2\end{matrix} \qquad ( 7 )$$

The solution is a₁=3, and a₂=9.

Similar to the MISO-GS(16,16) scheme, the optimal geometric shaping factors of the MISO-GS(4,4) and MISO-GS(8,8) schemes are respectively 0 and 3. As the two transmit signals are equivalent, the power normalization does not change the optimal power ratio.

### Regarding Hybrid GPS Policy

This policy addresses the problem of the optimal power ratio dynamically changing with the probabilistic shaping factor and applies probabilistic shaping to both transmit signals to maximize the probabilistic shaping gain.

The probabilistic shaping is applied to the GS SCM scheme, i.e. the hybrid GPS SCM scheme shown in FIG. 1. Compared with the probabilistic shaping at the receiver end, the probabilistic shaping at the transmit ends is more robust to a high peak-to-peak voltage (Vpp), and offers a larger drive Vpp dynamic range. Therefore, a Constant Composition Distribution Matching (CCDM) is used to perform probabilistic shaping on the transmit constellations, so as to enable same to conform to the optimal probability distribution of a QAM constellation, that is, the Maxwell-Boltzmann (MB) distribution. The probabilistic shaping should be performed on two equal-order M-QAM signals in the hybrid GPS SCM scheme. Following the probabilistic shaping of the MB distribution, the M-QAM probability distribution is as follows:

$${P}_{{X}_{i}} ( x ) = \frac{{e}^{- v {\vert x \vert}^{2}}}{{\sum }_{{x}^{′} ∈ {X}_{i}} {e}^{- v {\vert {x}^{′} \vert}^{2}}} , i = 1 , 2 \qquad ( 8 )$$

where Xᵢ represents a complex coordinate set of an ith lower order M-QAM constellation at the transmit ends, X={x₀, x₁, . . . , x_{M-1}}. x and x′ represent constellation symbols. v is a probabilistic shaping factor for controlling the source entropy (SE), a value of v is between 0 and 1.

There is a one-to-one mapping between the source entropy and the probabilistic shaping factor. For a given M-QAM signal, its information rate may be flexibly adjusted by changing the probabilistic shaping factor. The average power of the transmit constellations decreases as the probability of occurrence of the outer constellation points decreases. After power normalization, the transmit constellations with different source entropy have different constellation point positions. If two transmit constellations are equivalent, their constellation point changes are synchronized. In this case, the optimal power ratio does not change with the change of the probabilistic shaping factor. This feature reduces the complexity of the SCM MISO VLC system.

The probability distribution of the superposed constellation at the receiver end is determined by the superposition mechanism of each superposition scheme. Because the two transmit constellations are both M orders, the value of the probability distribution of the superposed constellation is:

$${P}_{{X}^{′}} = {P}_{{X}_{1}}^{T} \times {P}_{{X}_{2}} \qquad ( 9 )$$

where X′ is a complex coordinate set of the high-order M²-QAM constellation of the receiver end, X′={x₀, x₁, . . . , xₘ_{²}₋₁}.

The source entropy of the superposed constellation is expressed as:

$$H = - {\sum }_{x ∈ {X}^{′}} {P}_{{X}^{′}} ( x ) {log}_{2} ( {P}_{{X}^{′}} ( x ) ) \qquad ( 10 )$$

When the power ratio is 1, the probability distributions of the transmit constellations and the superposed constellation of each hybrid GPS SCM scheme are shown in FIG. 2.

### Regarding SCM-Based Hybrid GPS Rate-Adaptive MISO VLC Systems

In order to maximize the signal-to-noise ratio budget of each user and avoid bandwidth waste, modulation format switching and probabilistic shaping are applied to the transmit ends so as to implement rate adaptation, such that each user can implement a data rate close to channel capacity. In addition, MISO may further improve channel capacity of VLC systems. The SCM-based hybrid GPS rate-adaptive MISO VLC system is capable of increasing achievable data rates for all users while achieving flexible data rates.

Firstly, a mathematical model of a 2×1 SCM VLC system is established. The transmit signals are defined as:

$$x ( t ) = {[ {x}_{1} ( t ) , {x}_{2} ( t ) ]}^{T} \qquad ( 11 )$$

where x1 and x2 represent signals transmitted from a first LED (LED1) and a second LED (LED2), respectively.

The superposed constellation at the receiver end is expressed as:

$$y ( t ) = {\sum }_{i = 1}^{2} {h}_{i} ( t ) ⊗ {x}_{i} ( t ) + {n}_{i} ( t ) \qquad ( 12 )$$

where hᵢ(t) represents the channel response. i is an index of the LED. nᵢ(t) is noise.

The power ratio between LED1 and LED2 is defined as α, which is expressed as:

$$α = \frac{Vpp 2}{Vpp 1} \qquad ( 13 )$$

where Vpp1 and Vpp2 represent signals Vpp applied to LED1 and LED2, respectively. When a value of α is the optimal power ratio, the SCM MISO VLC system has the optimal performance.

Generalized Mutual Information (GMI) can accurately reflect the performance of a transmit signal, and is defined as:

$$GMI \approx - {\sum }_{x ∈ {X}^{′}} {P}_{{X}^{′}} ( x ) {log}_{2} ( {P}_{{X}^{′}} ( x ) ) + \frac{1}{N} {\sum }_{k = 1}^{N} {\sum }_{i = 1}^{m} {log}_{2} ( \frac{{\sum }_{x ∈ {X}_{{b}_{k , i}}^{′}} {q}_{Y \vert {X}^{′}} ( {y}_{k} \vert x ) {P}_{{X}^{′}} ( x )}{{\sum }_{x ∈ {X}^{′}} {q}_{Y \vert {X}^{′}} ( {y}_{k} \vert x ) {P}_{{X}^{′}} ( x )} ) \qquad ( 14 )$$

where b_{k,i∈}{0, 1} is an ith bit of a kth transmitted symbol.

$${X}_{{b}_{k , i}}^{′}$$

is a QAM symbol set with the ith bit being b_{k,i}. A modulation order of the superposed constellation is M², and m=log₂(M²). Y represents a reception sequence of length being N. q_{Y|X′}(yₖ|x)=1/\sqrt{2πσ²}e^{-|y}^{ₖ}^{-x|}^{²}^{/(2σ}^{²}⁾ is a channel probability mass function. σ² is a noise variance.

Normalized Generalized Mutual Information (NGMI) can accurately predict a bit error rate performance post Forward Error Correction (FEC) coding. The NGMI calculation for R-QAM and PS-QAM signals is as follows:

$$\{ \begin{matrix}{NGMI}_{R} = \frac{GMI}{m} \\ {NGMI}_{PS} = 1 - \frac{H - GMI}{m}\end{matrix} \qquad ( 15 )$$

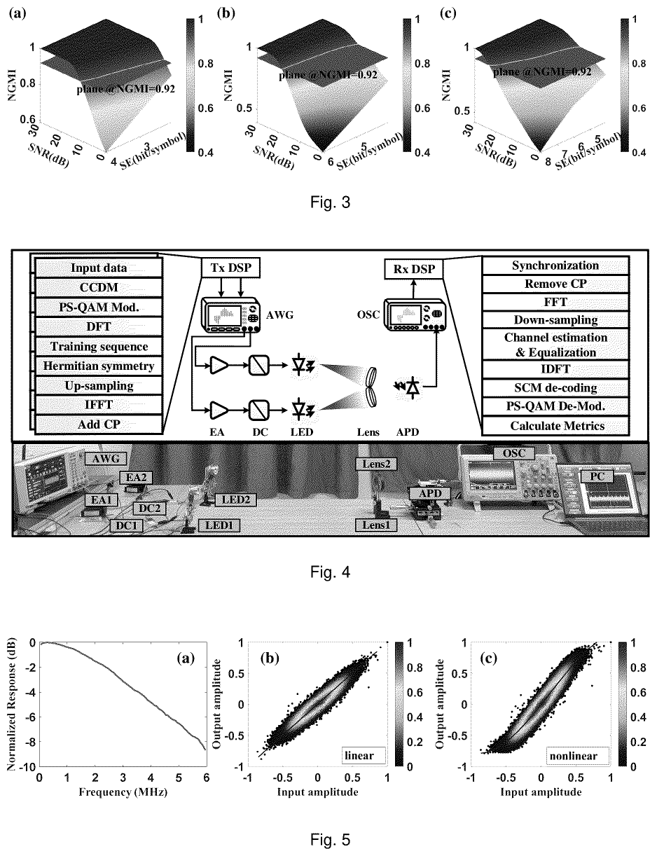

m denotes the number of bits transmitted per symbol; H denotes the source entropy; and there exists a correlation between a FEC code rate R_{c} and the NGMI threshold. For a given R_{c}, error-free transmission after FEC can only be achieved when the measured NGMI value exceeds the corresponding NGMI threshold. The R_{c} is fixed at 9/10 to avoid a plurality of FEC codewords and different frame structures, and the NGMI threshold corresponding to the R_{c} is 0.92. An NGMI lookup table is constructed for the SCM-based hybrid GPS rate-adaptive MISO VLC system, as shown in FIG. 3. The look-up table offers the relationship of NGMI, SNR and SE. Based on this lookup table and the estimated SNR, a maximum SE can be determined for each scheme that can satisfy the NGMI threshold.

After the FEC overhead is removed, the Net Transmission Spectral Efficiency (NTSE) is expressed as:

$$NTSE = H - ( 1 - {R}_{c} ) \cdot m \qquad ( 16 )$$

The net data rate (NDR) is expressed as:

$$NDR = NTSE \cdot B \qquad ( 17 )$$

where B denotes a modulation bandwidth of the system.

The achievable information rate characterizes the transmission capability of the system, and is expressed as:

$$AIR = GMI \cdot B \qquad ( 18 )$$

In order to clearly describe the method for implementing an SCM-based hybrid GPS rate-adaptive MISO VLC system, the following embodiments are provided to comprehensively evaluate GS, PS, MISO, and SCM-based hybrid GPS rate-adaptive MISO VLC system.

A 2×1 MISO VLC system is established to perform a concept experimental verification, and a system block diagram and an experimental device are as shown in FIG. 4. A Discrete Fourier Transform Spread Orthogonal Frequency Division Multiplexing (DFT-s-OFDM) is applied to suppress peak-to-average power ratio and inter-symbol interference. Firstly, two binary data streams are modulated into PS-QAM signals by means of CCDM. A Discrete Fourier Transform (DFT) spread-spectrum signal is then generated through the DFT. After the training sequence is inserted, Hermitian symmetry and upsampling are performed. A real-valued OFDM signal is obtained through the Inverse Fast Fourier Transform (IFFT). A Cyclic Prefix (CP) is then added before each OFDM time domain frame to resist multipath interference. Digital Signal Processing (DSP) at the transmit ends is performed through MATLAB.

The offline-generated transmit data stream is loaded to an arbitrary waveform generator (AWG: UNI-T UTG9604T) and output. The analog signal is then amplified by an electrical amplifier (EA: Mini-Circuits ZHL-6A-S+) and is coupled to direct current (DC) via a biaser (Mini-circuits ZFBT-4R2GWFT+). The electrical signal is converted into an optical signal by two commercial red LEDs (Cree XLamp XPE-2). After free-space propagation, the optical signal is detected by an avalanche photodiode (APD: Hamamatsu C12702-11) and is converted to an electrical signal. A lens is placed before the APD to collect light, so as to improve the received optical power. The electrical signal is sampled and recorded by an oscilloscope (OSC: Tektronix MDO3034), and then is forwarded for offline processing.

After synchronization and CP removal, OFDM demodulation is performed by means of Fast Fourier Transform (FFT) and down sampling. Channel distortion is compensated by means of frequency domain channel estimation and equalization. Time domain symbols are obtained by an Inverse Discrete Fourier Transform (IDFT). SCM decoding and PS-QAM demodulation are performed based on the concept of superposed constellation demapping. Finally, the performance metrics are calculated.

The specific experimental parameters are as follows: DFT points are 122, FFT points are 256, and CP length is 8. The 6 low-frequency sub-carriers are padded with zeros due to poor EA response. The up-sampling factor is 2. The sampling rate of the AWG is 25 MSa/s. DC is 100 mA. LED spacing is 40 cm. The transmission distance is between 65 cm to 185 cm. The effective bandwidth of the system is about 5.96 MHz. FIG. 5 illustrates the experimental system features of frequency response, amplitude-amplitude response, etc. section (a) of FIG. 5 illustrates the frequency response; section (b) of FIG. 5 illustrates the amplitude-amplitude response in a linear region; and section (c) of FIG. 5 illustrates the amplitude-amplitude response in a nonlinear region.

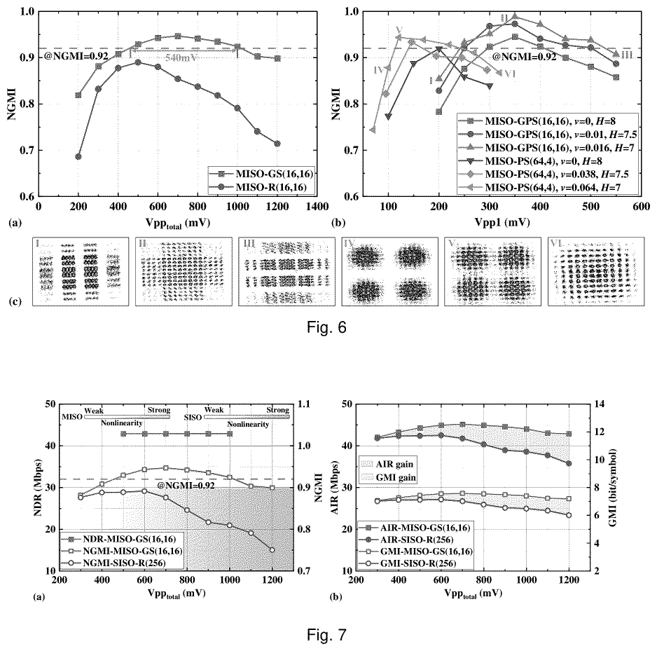

First, the superiority of the GS is verified by taking the MISO-GS(16,16) and MISO-GPS(16,16) schemes as an example, as shown in FIG. 6. Conventional MISO-R(16,16) and MISO-PS(64,4) schemes are introduced for comparison.

Section (a) of FIG. 6 describes NGMI performances of MISO-GS(16,16) and MISO-R(16,16) schemes at different Vpp (Vppₜₒₜₐₗ), Vppₜₒₜₐₗ=Vpp1+Vpp2. The two equivalent transmit signals of each scheme are sent by two LEDs, respectively. The optimal PRs for the MISO-GS(16,16) and MISO-R(16,16) schemes are 1 and 4, respectively. In experiments, all schemes use the optimal PR. Thus, for the MISO-GS(16,16) scheme, Vpp1=Vpp2. For the MISO-R(16,16) scheme, Vpp2/Vpp1=4. Thanks to balanced power allocation, the NGMI performance of the MISO-GS(16,16) scheme consistently outperforms that of the MISO-R(16,16) scheme, and offers a drive Vppₜₒₜₐₗ dynamic range of approximately 540 mV. The experimental results demonstrate the significant advantages of GS.

Section (b) of FIG. 6 illustrates the NGMI performances of the MISO-GPS(16,16) and MISO-PS(64,4) schemes at different Vppₜₒₜₐₗ. The two equivalent GPS-16QAM signals of the MISO-GPS(16,16) scheme are sent by two LEDs, respectively. The PS-64QAM and R-4QAM signals of the MISO-PS(64,4) scheme are sent by LED1 and LED2, respectively. In the experiment, Vpp2 is fixed at 350 mV. The PR gradually decreases as Vpp1 increases. The constellation point distribution of the superimposed constellation varies as the PR varies. When Vpp2/Vpp1 achieves the optimal PR, the superimposed constellation is uniformly distributed with the maximum MED, and the NGMI reaches its peak value. The constellation diagram shown in section (c) of FIG. 6 confirms this. When the PSF changes, the MISO-GPS(16,16) scheme always achieves the best NGMI performance when the PR is 1, while the NGMI peak point of the MISO-PS(64,4) scheme changes constantly. The dynamically changing optimal PR introduces additional complexity to the SCM-based MISO VLC system. The experimental results demonstrate the advantage of designing two equivalent GS transmit signals.

The advantages of multi-transmitter systems over single-transmitter systems against nonlinear effects are then verified by taking the MISO-GS(16,16) and SISO-R(256) schemes as an example, as shown in FIG. 7. The R-256QAM signal of the SISO-R(256) scheme is sent by LED1, and Vppₜₒₜₐₗ=Vpp1. As shown in section (a) of FIG. 7, the nonlinearities of the MISO and SISO VLC systems both increase with the increase of Vppₜₒₜₐₗ. The SCM-based MISO VLC system enters a nonlinear interval later than the SISO VLC system by dispersing Vppₜₒₜₐₗ equally over two LEDs, and significantly improves tolerance to high Vppₜₒₜₐₗ. Therefore, the NGMI and NDR performances of the MISO-GS(16,16) scheme is always superior to the SISO-R(256) scheme. Section (b) of FIG. 7 further describes the AIR and GMI performances of the MISO-GPS(16,16) and MISO-PS(64,4) schemes. The MISO-GPS(16,16) scheme has higher signal transmission quality, and achieves considerable AIR and GMI gains.

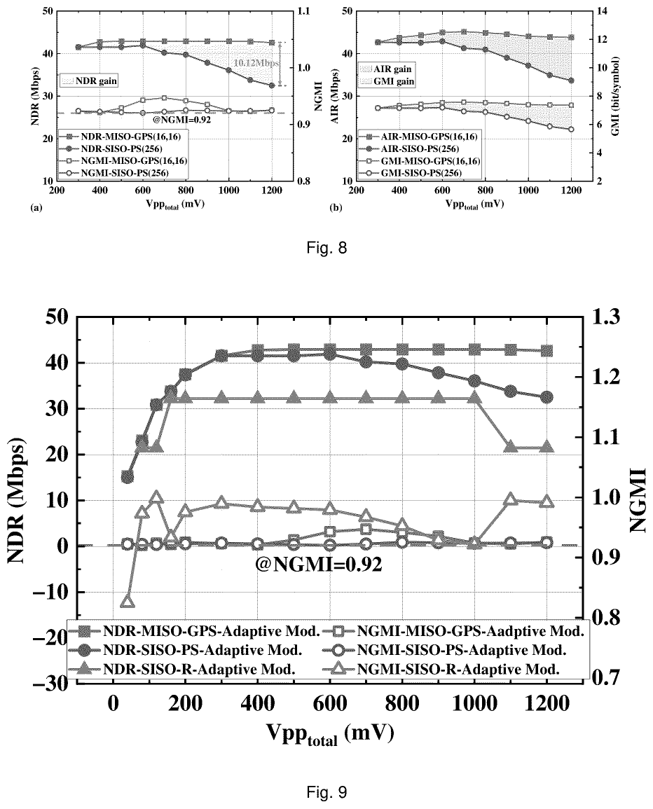

Next, the performance gain brought by the PS is verified by taking the MISO-GPS(16,16) and SISO-PS(256) schemes as an example, as shown in FIG. 8. For the MISO-GPS(16,16) scheme, Vpp1=Vpp2. As shown in section (a) of FIG. 8, in comparison to the MISO-GS(16,16) and SISO-R(256) schemes without PS shown in section (a) of FIG. 7, the NGMI measurement values of the MISO-GPS(16,16) and SISO-PS(256) schemes at all drive Vppₜₒₜₐₗ are above error-free transmission threshold after FEC. By increasing the MED of the superimposed constellation and increasing robustness to nonlinear distortions, the PS brings significant shaping gains. Although PS significantly enhances the performance of the SISO-PS(256) scheme, the MISO-GPS(16,16) scheme still achieves considerable NDR gains. The greater the PS depth for the SISO-PS(256) scheme results in greater loss of SE. Comparing section (b) of FIG. 7 and section (b) of FIG. 8, the AMR and GMI gains of the MISO-GPS(16,16) scheme are increased upon application of PS.

Finally, the advantages of the SCM-based hybrid GPS rate-adaptive MISO VLC system (MISO-GPS-Adaptive Mod.) are verified. The existing R-QAM modulation format switching SISO VC system (SISO-R-Adaptive Mod.) and the PS-QAM modulation format switching SISO VLC system (SISO-PS-Adaptive Mod.) are introduced for comparison.

FIG. 9 describes the NDR and NGMI performances of three rate-adaptive VLC systems at different Vppₜₒₜₐₗ. At all Vppₜₒₜₐₗ values, by adjusting the PSF and the modulation format, the MISO-GPS-Adaptive Mod. and SISO-PS-Adaptive Mod. systems can reach the NGMI threshold value and achieve flexible fine-grained NDR. At high Vppₜₒₜₐₗ values, the MISO-GPS-Adaptive Mod. system suffers from less linearity and has better performance than the SISO-PS-Adaptive Mod. system. The SISO-R-Adaptive Mod. system can only adjust the rate by switching the modulation format, and therefore can only achieve two discrete NDRs. When the value of NGMI is higher than 0.92, the bandwidth resources of the SISO-R-Adaptive Mod. system are not fully utilized.

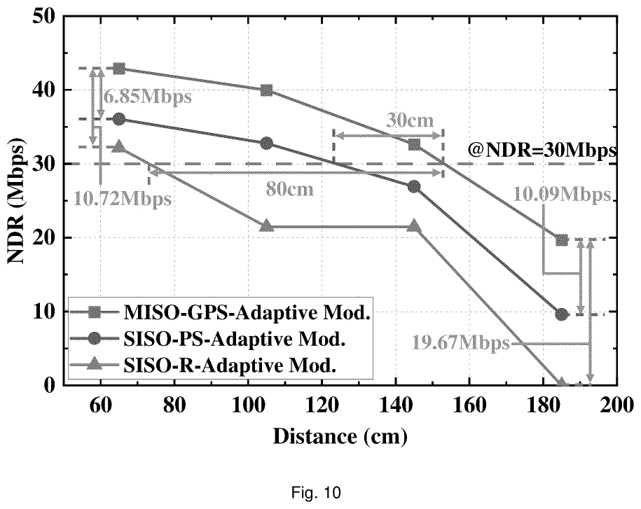

FIG. 10 describes the NDR performances of three distance-based multi-user rate-adaptive VLC systems. In the experiment, Vppₜₒₜₐₗ is fixed at 1000 mV. Compared with the SISO-PS-Adaptive Mod. system, the near-end users and the far-end users of the MISO-GPS-Adaptive Mod. system achieve approximately 19% and 105% NDR gains, respectively. Compared with the SISO-R-Adaptive Mod. system, the MISO-GPS-Adaptive Mod. system not only achieves a considerable NDR gain, but also achieves flexible rate adjustment. Under the 30 Mbps NDR constraint, the MISO-GPS-Adaptive Mod. system improves the maximum transmission distances of the SISO-PS-Adaptive Mod. and SISO-R-Adaptive Mod. systems by about 24.5% and 111%, respectively.

Compared with the related art, the present disclosure achieves the following beneficial effects:
1. Compared with the existing conventional modulation format switching rate-adaptive SISO VLC and probabilistic shaping rate-adaptive SISO VLC technologies, the proposed SCM-based hybrid GPS rate-adaptive multiple-input single-output visible light communication (MISO VLC) system in the present disclosure can provide a flexible and fine-grained net data rate (NDR) for each user while improving the overall NDR performance for all users.
2. Compared with the traditional SISO systems, the present disclosure adopts a plurality of transmit ends to distribute the total power across a plurality of LEDs, reducing the risk of nonlinear distortion in LEDs under the same total power budget, increasing the system's maximum transmit power tolerance, and thereby improving the received signal-to-noise ratio.
3. The geometric-probabilistic hybrid shaping policy proposed by the present disclosure enhances the robustness of the system to non-ideal factors such as non-linear distortion, high channel correlation, power contend, and dynamic change of power ratio. The general approach to solve for the optimal Geometric Shaping Factor (GSF) provides a technical paradigm for designing a superimposed even-order constellation.

Finally, it should be noted that the above examples of the present disclosure are only examples for illustrating the present disclosure, rather than limiting the embodiments of the present disclosure. Although the present disclosure has been described in detail with reference to preferred embodiments, for a person of ordinary skill in the art, other variations or modifications of different forms may be made on the basis of the described illustration. Herein, it is impossible to list all embodiments in an exhaustive manner. All obvious variations or modifications made to the technical solutions of the present disclosure are still within the scope of protection of the present disclosure.

What is claimed is:

1. A method for implementing a rate-adaptive multi-input single-output visible light communication system, wherein the visible light communication system comprises transmit ends and a receiver end, and there are a plurality of transmit ends and one receiver end, thereby forming the multi-input single-output visible light communication system; each transmit end corresponds to one light source; respectively modulating binary transmission data streams corresponding one-to-one to the plurality of transmit ends onto a constellation diagram so as to increase spectrum efficiency and then obtain transmit constellations, loading all the transmit constellations onto a signal generator after subjected to digital signal processing, outputting, by the signal generator, a plurality of analog signals corresponding to a number of the transmit constellations, respectively amplifying, by electrical amplifiers, the plurality of analog signals, and then respectively coupling, by biasers, the plurality of analog signals to direct current to obtain a plurality of electric signals, and converting, by light sources corresponding to the plurality of transmit ends, the plurality of electric signals obtained by means of coupling into optical signals, and the receiver end is used for receiving the optical signals;
performing probabilistic shaping respectively on all the transmit constellations so as to enable same to conform to Maxwell-Boltzmann distribution of a Quadrature Amplitude Modulation (QAM) constellation; and performing geometric shaping on all the transmit constellations at the same time to make a transmit signal power of each transmit end equal.

2. The method for implementing the rate-adaptive multi-input single-output visible light communication system according to claim 1, wherein during probabilistic shaping, using a Constant Composition Distribution Matching to perform probabilistic shaping on the transmit constellations, and in a case that there are two transmit ends, a probability distribution of QAM signals of which a modulation order is M is:
$${P}_{{X}_{i}} ( x ) = \frac{{e}^{- v {\vert x \vert}^{2}}}{{\sum }_{{x}^{′} ∈ {X}_{i}} {e}^{- v {\vert {x}^{′} \vert}^{2}}} , i = 1 , 2$$
wherein Xᵢ represents a complex coordinate set of an ith lower order M-ary Quadrature Amplitude Modulation (M-QAM) constellation of the transmit ends, and X={x0, x1, . . . , xM−1}; x and x′ represent constellation symbols; v is a probabilistic shaping factor for controlling the source entropy (SE), a value of which is between 0 and 1; and there is a one-to-one mapping relationship between the SE and the probabilistic shaping factor v.

3. The method for implementing the rate-adaptive multi-input single-output visible light communication system according to claim 2, wherein the SE is determined according to the following steps,
1) establishing a lookup table indicating a relationship of at least one normalized generalized mutual information, at least one signal-to-noise ratio and the at least one SE;
2) determining a threshold of the normalized generalized mutual information as a value of normalized generalized mutual information for lookup; and
3) obtaining the signal-to-noise ratio by means of estimation, and based on the lookup table of step 1), determining a maximum SE of each scheme which can satisfy the threshold of the normalized generalized mutual information.

4. The method for implementing the rate-adaptive multi-input single-output visible light communication system according to claim 1, wherein during geometric shaping, solving an optimal geometric shaping factor in advance, and then performing geometric shaping on the transmit constellations based on the obtained optimal geometric shaping factor, wherein the optimal geometric shaping factor is defined as a geometric shaping factor when each transmit signal power ratio is equal to 1 and superposed constellations of the receiver end are evenly distributed.

5. The method for implementing the rate-adaptive multi-input single-output visible light communication system according to claim 4, wherein the optimal geometric shaping factor is determined according to the following steps,
a) adding geometric shaping factors to an in-phase component and a quadrature component of two transmit signals, respectively;
b) presetting an optimal power ratio of the two transmit signals to be 1, and obtaining a symbol set of the superimposed constellations of the receiver end;
c) forming the elements of the symbol set into an arithmetic progression with a tolerance of the minimum Euclidean distance; and
d) establishing an equation set with regard to the geometric shaping factor based on the arithmetic progression in step c), wherein the geometric shaping factor obtained by solving the equation set is the optimal geometric shaping factor.

6. The method for implementing the rate-adaptive multi-input single-output visible light communication system according to claim 4, wherein a superposed constellation of the receiver end is expressed as:
$$y ( t ) = {\sum }_{i = 1}^{2} {h}_{i} ( t ) ⊗ {x}_{i} ( t ) + {n}_{i} ( t ) ;$$
wherein hᵢ(t) represents the channel response. i is an index of the LED. nᵢ(t) is noise.

7. The method for implementing the rate-adaptive multi-input single-output visible light communication system according to claim 1, wherein the light sources are LEDs (Light Emitting Diode).

8. The method for implementing the rate-adaptive multi-input single-output visible light communication system according to claim 1, wherein two transmit signals of each Geometric Shaping (GS) Superposition Coded Modulation (SCM) scheme have a same amplitude and different phases.

9. The method for implementing the rate-adaptive multi-input single-output visible light communication system according to claim 8, wherein the two transmit signals of a MISO-GS(4,4) scheme are 4QAM signals in an in-phase (I) component and a quadrature (Q) component respectively.

10. The method for implementing the rate-adaptive multi-input single-output visible light communication system according to claim 8, wherein the two transmit signals of a MISO-GS(8,8) scheme are two GS-8QAM signals.

11. The method for implementing the rate-adaptive multi-input single-output visible light communication system according to claim 8, wherein the two transmit signals of a MISO-GS(16,16) scheme are two GS-16QAM signals.
